(19) United States
(12) Patent Application Publication
(10) Pub. No.: US 2014/0279451 A1
(43) Pub. Date: Sep. 18, 2014

(54) Escrow Payment System for Transactions

(71) Applicant: FEDBID, INC., Vienna, VA (US)

(72) Inventors: Ali Saadat, McLean, VA (US); Luther Tupponce, Vienna, VA (US); Vinay Vittal, Herndon, VA (US); Karen Redman, Falls Church, VA (US); Joseph Sorisi, Old Brookville, NY (US)

(73) Assignee: FEDBID, INC., Vienna, VA (US)

(21) Appl. No.: 13/833,264

(22) Filed: Mar. 15, 2013

(51) Int. Cl. G06Q 20/10

(52) U.S. Cl. CPC G06Q 20/102
USPC 705/40

(57) ABSTRACT

An apparatus, method, and computer-readable storage medium for coordinating payment between a payor and a payee of a transaction for a contractual obligation includes electronically receiving of payor and payee bank account information, electronically receiving transaction information, and electronically transmitting a debit request to a payment processor. The debit request includes instructions to create a discrete financial account for the online transaction, debit an amount from the payor's bank account, and hold the debited amount in the discrete financial account. After the contractual obligation is satisfied, a credit request is electronically transmitted to a payment processor. The credit request includes instructions to credit the payee's bank account with a payment amount from funds held in the discrete financial account.

### BACKGROUND OF THE INVENTION

1. Field of the Invention

The invention relates to an escrow payment system for facilitating payment between a payor and a payee, such as a buyer and a seller conducting an online transaction.

2. Description of the Related Art

The Internet has become a preferred global platform for buying and selling goods and services. Using the Internet, potential buyers and sellers conduct and manage these transactions without needing to be physically present to complete the transaction. Various shipping companies are available to deliver purchased goods.

Numerous online web sites exist to facilitate these sales and unite potential buyers and sellers. These sites customarily allow participants to list items for sale or items that a participant seeks to purchase, and permit anyone on the Internet to at least view, browse, and/or search these listings. Interested sellers and buyers are then connected with each other.

One popular type of these web sites is online auction sites. Auctions utilize a free-market approach to assess the actual market value of the goods and services, by introducing competition and allowing the marketplace to set the pricing according to demand.

Online auctions can be organized in many different formats. Two distinct approaches are the “forward auction” and “reverse auction” configurations. In a forward auction, a seller creates an auction listing for one or more goods or services, and the bidders are buyers looking to purchase the auction item(s) in the listing. Customarily, the seller will set a low initial price, and each successive bidder will submit a successively higher bid until the auction ends. The highest bidder at the end of the auction is the winner and receives the auction item(s) in exchange for payment of the bid amount.

In a reverse auction, it is a buyer, not a seller, who creates an auction listing. The buyer is seeking a particular good or service (or multiple goods or services) and creates the auction listing with a request for such items, seeking sellers to accommodate the request. The bidders in a reverse auction are potential sellers looking to accommodate the items for a price. The buyer will often set a high initial price, and each successive bidder will submit a successively lower bid until the auction ends. The lowest bidder at the end of the auction is typically the winner and receives the bid amount in exchange for providing the requested item(s) to the buyer. It is noted that some auctions may incorporate award criteria besides simply pricing. For instance, in a reverse auction, a buyer may utilize award criteria other than price, such that the lowest bidder may not necessarily be the winner as selected by the buyer.

Many auction transactions involve buyers and sellers who are unfamiliar with each other prior to participating in the auction. This unfamiliarity creates inherent risks in conducting the transaction. Accordingly, an auction bidder may rely on word-of-mouth, reputation, ratings, written feedback, and/or any other information relating to the other party, in predicting the other party's reliability in completing a transaction. Such reliability may be a factor as to whether the bidder decides to enter a bid.

One particular risk arises during the conventional transfers of the auction payment and the goods between the buyer and the seller. When an up-front payment is required prior to shipment of the goods, the buyer holds a risk that the seller does not ship the goods even after accepting the payment, or that the goods are defective. Meanwhile, the seller holds a risk that the buyer's payment is defective, but such defect is not revealed until after the seller ships the goods.

Conversely, if payment is to be provided following shipment and/or inspection of the goods, the seller holds a risk that the buyer will not make the required payment or that a payment will be defective.

One approach to reduce the risk in these types of transactions is to use an escrow service. A typical escrow service is a neutral third-party vendor appointed to facilitate the transaction by holding the buyer's payment during pendency of the transaction, and then distributing the payment to designated parties such as the seller after the delivery is complete. With this approach, the escrow service assures the seller that the buyer has indeed submitted a payment, and that the submitted funds are genuine. The escrow service typically charges a fee for these services. It will be appreciated that the escrow service may alternatively or additionally hold and distribute the auction goods in accordance with the arrangement between the buyer and seller.

In managing the payment for the auction, the escrow service typically collects the payment from the buyer and then maintains the payment in a financial account. Upon acceptance of the goods by the buyer, the escrow service distributes the payment from the financial account to the seller. The payments may be provided in paper form (e.g., check) or may be provided via ACH or wire transfer.

Typical escrow services are configured to handle individual transactions and typically incorporate manual activity to conduct each individual transaction. An escrow service may employ mechanisms to identify and distinguish received funds.

One conventional approach adopted by escrow services is to allocate and associate a financial account with a specific participant. The specific participant may be either the particular buyer or the particular seller. This financial account is then re-used for all subsequent transactions involving the same participant. The financial account may be situated at a financial institution, such as a bank.

Escrow services using this approach may prefer a customer base having frequent return business, to minimize expenses and labor associated with creating an individual account for each new customer. These expenses and labor may inhibit the potential growth of the escrow service.

This approach also results in commingling of funds. If the same buyer and seller engage in multiple transactions, the same account is continuously re-used in all the transactions. If the account is associated with the buyer, payments for subsequent transactions involving the buyer, but a different seller, may still be stored in this account. If the account is associated with the seller, payments for subsequent transactions involving the seller, but a different buyer, may still be stored in this account.

If the participant (e.g., buyer) is involved with numerous concurrent transactions, the accounting required to track each payment may become overwhelming. Moreover, the funds from different transactions (e.g., from different sellers) become commingled.

Some basic escrow services may even forego accounts for each participant. In such circumstances, the escrow service may simply store payment funds in its general financial account, and attempt to maintain the appropriate accounting. With this approach, funds are continuously being commingled.

The growing presence of escrow services have also increased their popularity among other transactions beyond those conducted on the Internet and/or via auctions. Indeed, an escrow service can be applied for any transaction between a payor and a payee.

On top of commingling concerns, governmental entities have instituted regulations for financial institutions, requiring them to verify the identity of their customers prior to conducting business with them. These government-mandated security checks are generally known as “Know Your Customer” (KYC) checks, and may verify that a customer has not been suspected of involvement in criminal activity such as terrorism or money-laundering. As an example, in the United States, the following sources may be queried:
(1) Bureau of Industry & Security
(2) DTC Debarred Parties
(3) Enterprise Wide Internal Watch list
(4) EU Consolidated
(5) Factiva PFA (Africa, Asia, Canada, Europe, Middle East, North America, South America, Unknown, USA)
(6) Financial Action Task Force
(7) FBI Hijack Suspects
(8) FBI Most Wanted
(9) FBI Most Wanted Terrorists
(10) FBI Seeking Information
(11) FBI Top Ten Most Wanted
(12) Nonproliferation Sanctions
(13) OFAC Non-SDN Entities
(14) OFAC Sanctions
(15) OFAC SDN
(16) Primary Money Laundering Concerns (Countries)
(17) Primary money Laundering Concerns (Entities)
(18) Terrorist Exclusion List
(19) UN Consolidated List

However, escrow services may not be equipped to easily conduct these KYC checks. As these checks should be performed prior to any transfer of payment, an escrow service may be overburdened with KYC checks for transactions having many potential participants (e.g., potential bidders in an auction).

Financial institutions, on the other hand, are equipped to conduct KYC checks, as they have these mechanisms in place to verify new customers.

Accordingly, there is a need in the art for an escrow service that efficiently facilitates and holds a payment between a payor and a payee, while avoiding the commingling and mis-identification of funds. There is also a need in the art for an efficient and secure system for coordinating a transaction between an online site (such as an auction site), an escrow service, and a financial institution that processes the transaction payment. There is further a need in the art for an escrow service that efficiently conducts KYC checks prior to initiating a payment transfer and hold.

### SUMMARY OF THE INVENTION

The present invention addresses the challenges in the art discussed above. With increasing concerns over lax accounting practices, customers of escrow services may insist that funds for every transaction be separately stored, so as to avoid any commingling of these funds. These customers may even insist that funds from different transactions, even involving the same buyer and seller, be separately held. Customers may also demand frequent status updates on the transfers of each of these funds.

In the following description, it will be appreciated that the invention, in one aspect, relates to (1) the non-commingling of funds (e.g., an auction service's operating account is maintained separately from those of its buyers and sellers); and (2) the preservation of identity of funds on a transaction level (e.g., identity of funds is maintained for every transaction, not simply for a specific buyer or seller).

An aspect of the invention relates to a method of coordinating payment between a payor and a payee of a transaction for a contractual obligation, comprising electronically receiving bank account information from an online entity administering the transaction, the bank account information including information on (1) a payor bank account corresponding to the payor, and (2) a payee bank account corresponding to the payee; electronically receiving transaction information from the online entity, the transaction information including a payment amount to be paid by the payor to the payee for the contractual obligation; electronically transmitting a debit request to a payment processor, the debit request including instructions to (1) create a discrete financial account specific to the transaction, (2) debit, from the payor bank account, a debit amount equal to or greater than the payment amount, (3) transfer the debit amount to the discrete financial account, and (4) hold the debit amount in the discrete financial account; and electronically transmitting, after a confirmation that the contractual obligation has been at least partially satisfied, a credit request to the payment processor, the credit request including instructions to (1) transfer a credit amount from the discrete financial account, and (2) credit, to the payee bank account, the payment amount, wherein said bank account information electronic receiving step, said transaction information electronic receiving step, said debit request electronic transmitting step, and said credit request electronic transmitting step are implemented using at least one processor and at least one memory.

Another aspect of the invention relates to a method of coordinating a plurality of payments, each payment corresponding to a transaction between a payor and a payee for a contractual obligation, comprising electronically receiving, for each of the transactions, bank account information from an online entity administering the transaction, the bank account information including information on (1) a payor bank account corresponding to the respective payor, and (2) a payee bank account corresponding to the respective payee; electronically receiving, for each transaction, transaction information from the online entity, the transaction information including a payment amount to be paid by the respective payor to the respective payee for the respective contractual obligation; electronically transmitting, for each of the transactions, a debit request to a payment processor, the debit request including instructions to (1) create a discrete financial account specific to the transaction, (2) debit, from the respective payor bank account, a debit amount equal to or greater than the respective payment amount, (3) transfer the debit amount to the discrete financial account, and (4) hold the debit amount in the discrete financial account; and electronically transmitting, for each of the transactions and after confirmation that the contractual obligation has been at least partially satisfied, a credit request to the payment processor, the credit request including instructions to (1) transfer a credit amount from the respective discrete financial account, and (2) credit, to the respective payee bank account, the respective payment amount, wherein said bank account information electronic receiving step, said transaction information electronic receiving step, said debit request electronic transmitting step, and said credit request electronic transmitting step are implemented using at least one processor and at least one memory.

Yet another aspect of the invention relates to a method of coordinating a plurality of payments, each payment corresponding to an online transaction between a seller and a buyer for an item, comprising electronically receiving, for each of the online transactions, bank account information from an online entity administering the online transaction, the bank account information including information on (1) a seller bank account corresponding to the respective seller, and (2) a buyer bank account corresponding to the respective buyer; electronically receiving, for each of the online transactions, transaction information from the online entity, the transaction information including a payment amount to be paid by the respective buyer to the respective seller for the respective item; electronically transmitting a batch debit request to a payment processor, the batch debit request including instructions to, for each of the online transactions, (1) create a discrete financial account specific to the online transaction, (2) debit, from the respective buyer bank account, a debit amount equal to or greater than the respective payment amount, (3) transfer the debit amount to the discrete financial account, and (4) hold the debit amount in the discrete financial account; and electronically transmitting a batch credit request to the payment processor, the batch credit request including instructions to, for each of the online transactions having a confirmation that the respective buyer has received the respective item, (1) transfer a credit amount from the respective discrete financial account, and (2) credit, to the respective seller bank account, the payment amount, wherein said bank account information electronic receiving step, said transaction information electronic receiving step, said debit request electronic transmitting step, and said credit request electronic transmitting step are implemented using at least one processor and at least one memory

Still another aspect of the invention relates to a method of coordinating payment between a seller and a buyer of an online transaction for an item, comprising electronically receiving bank account information, the bank account information including information on (1) a seller bank account corresponding to the seller, and (2) a buyer bank account corresponding to the buyer; checking the seller bank account and the buyer bank account for security compliance; electronically receiving transaction information, the transaction information including a payment amount to be paid by the buyer to the seller for the item; electronically creating a discrete financial account specific to the online transaction; electronically debiting, from the buyer bank account, a debit amount equal to or greater than the payment amount; electronically transferring the debit amount to the discrete financial account; holding the debit amount in the discrete financial account; electronically receiving a notification that the buyer has received the item; electronically transferring a credit amount from the discrete financial account; and electronically crediting, to the seller bank account, the credit amount, wherein said bank account information electronic receiving step, said transaction information electronic receiving step, said electronic creating step, said electronic debiting step, said debit amount electronic transferring step, said notification electronic receiving step, said credit amount electronic transferring step, and said electronic crediting step are implemented using at least one processor and at least one memory.

Another aspect of the invention relates to an apparatus for coordinating payment between a payor and a payee of a transaction for a contractual obligation, comprising a bank account information reception module that receives, from an online entity administering the transaction, bank account information including information on (1) a payor bank account corresponding to the payor, and (2) a payee bank account corresponding to the payee; a transaction information reception module that receives, from the online entity, the transaction information including a payment amount to be paid by the payor to the payee for the contractual obligation; a debit request transmission module that transmits, to a payment processor, a debit request including instructions to (1) create a discrete financial account specific to the transaction, (2) debit, from the payor bank account, a debit amount equal to or greater than the payment amount, (3) transfer the debit amount to the discrete financial account, and (4) hold the debit amount in the discrete financial account; and a credit request transmission module that transmits, after a confirmation that the contractual obligation has been at least partially satisfied, a credit request to the payment processor, the credit request including instructions to (1) transfer a credit amount from the discrete financial account, and (2) credit, to the payee bank account, the payment amount.

A further aspect of the invention relates to a computer program product comprising a non-transitory computer readable medium having control logic stored thereon for causing a computer to coordinate payment between a payor and a payee of a transaction for a contractual obligation, the control logic comprising computer readable program code which, when executed, causes the computer to perform the steps of electronically receiving bank account information from an online entity administering the transaction, the bank account information including information on (1) a payor bank account corresponding to the payor, and (2) a payee bank account corresponding to the payee; electronically receiving transaction information from the online entity, the transaction information including a payment amount to be paid by the payor to the payee for the contractual obligation; electronically transmitting a debit request to a payment processor, the debit request including instructions to (1) create a discrete financial account specific to the transaction, (2) debit, from the payor bank account, a debit amount equal to or greater than the payment amount, (3) transfer the debit amount to the discrete financial account, and (4) hold the debit amount in the discrete financial account; and electronically transmitting, after a confirmation that the contractual obligation has been at least partially satisfied, a credit request to the payment processor, the credit request including instructions to (1) transfer a credit amount from the discrete financial account, and (2) credit, to the payee bank account, the payment amount.

Further features and advantages, as well as the structure and operation, of various example embodiments of the present invention are described in detail below with reference to the accompanying drawings.

### BRIEF DESCRIPTION OF THE DRAWINGS

The features and advantages of the example embodiments of the invention presented herein will become more apparent from the detailed description set forth below when taken in conjunction with the drawings. Like reference numbers between two or more drawings can denote identical or functionally similar elements unless the description indicates otherwise.

FIG. 1 is a system diagram showing an online auction system according to one aspect of the invention.

FIG. 2 is a block diagram showing physical components of the auction server according to one aspect of the invention.

FIG. 3 is a block diagram showing software components running on the auction server according to the same aspect of the invention as illustrated in FIG. 2.

FIG. 4 is a block diagram showing physical components of the escrow payment server according to one aspect of the invention.

FIG. 5 is a block diagram showing software components running on the escrow payment server according to the same aspect of the invention as illustrated in FIG. 4.

FIG. 6 is a block diagram showing physical components of the payment processor server according to one aspect of the invention.

FIG. 7 is a block diagram showing software components running on the payment processor server according to the same aspect of the invention as illustrated in FIG. 6.

FIG. 8 is an organization chart showing the relationships of entities associated with the online auction system.

FIGS. 9A-9C are flow-charts with steps for implementing a first method for operating the escrow payment server and payment processing server.

FIG. 10 is a sequence diagram showing the sequence of steps by each entity, in executing the first method.

FIG. 11 is a block diagram showing the financial accounts involved in the online auction system of FIG. 1.

FIG. 12 is a sequence diagram showing a first method of processing fund transfers according to a real-time processing methodology that may be utilized with the invention.

FIG. 13 is a sequence diagram showing a second method of processing fund transfers according to a batch processing methodology that may be utilized with the invention.

FIG. 14 is a sequence diagram showing a third method of processing fund transfers according to a hybrid real-time/batch processing methodology that may be utilized with the invention.

FIG. 15 is a diagram showing an example of a release file that may be used with the third method of processing fund transfers.

FIG. 16 is a system diagram showing an online transaction system according to another aspect of the invention.

FIG. 17 is a block diagram showing physical components of the online business according to an aspect of the invention.

FIG. 18 is a block diagram showing software components running on the online business according to the same aspect of the invention as illustrated in FIG. 17.

FIGS. 19A-19C are flow-charts with steps for implementing a second method for operating the escrow payment server and payment processing server.

FIG. 20 is a system diagram showing an online transaction system according to a third aspect of the invention.

FIGS. 21A-21B are flow-charts with steps for implementing a third method for operating the escrow payment server and payment processing server.

FIG. 22 is a sequence diagram showing the sequence of steps by each entity, in executing the third method.

### DETAILED DESCRIPTION OF THE INVENTION

FIG. 1 shows an online auction system 100 that may carry out the features in accordance with one aspect of the present invention. Auction system 100 includes an auction server 110, an escrow payment service (EPS) server 150, and a payment processor server 160. Auction server 110 is connected to a network 120 (such as the Internet) via a network link 121. EPS server 150 is connected to network 120 via a network link 122. Payment processor server 110 is connected to network 120 via a network link 123. It will be appreciated that auction server 110, EPS server 150, and payment processor server 160 may alternatively be connected through dedicated and/or private network links or other methods of information exchange.

The auction system 100 also includes at least one auction-listing submission device 130 and at least one bid submission device 140. Auction-listing submission device 130 is connected to network 120 via a network link 131, and bid submission device 140 is connected to network 120 via a network link 141. In a preferred embodiment, auction-listing submission device 130 and bid submission device 140 are personal computers. However, it will be appreciated that the devices may alternatively include cellular telephones (e.g., smartphones), tablets, terminals, or any other devices capable of submitting electronic information to the auction system 100.

Auction-listing submission device 130 is operated by an individual or other entity (e.g., corporate or government) desiring to initiate an auction listing. In the case of a forward auction, the auction listing is for the sale of one or more goods or services, whereas for a reverse auction, the auction listing is a request for the desired purchase of one or more goods or services.

Bid submission device 140 is operated by an individual or other entity (e.g., corporate or government) desiring to submit a bid for the auction listing initiated by an auction-listing submission device 130. In the case of a forward auction, the bid is for the purchase of the one or more goods or services, whereas for a reverse auction, the bid is for the sale of the one or more goods or services, thereby satisfying the request for the desired purchase.

It will be understood that auction system 100 may include multiple auction-listing submission devices 130 and multiple bid submission devices 140, each connected to network 120. It will also be appreciated that any auction-listing submission device 130 and/or bid submission device 140 may communicate with the auction server 110 via a web browser, dedicated software, text messaging, or any other form of data communication.

It will be further appreciated that payment processor associated with payment processor server 160 may be a financial institution or any other service capable of processing and/or transferring funds. It will be additionally appreciated that the payment processor may actually constitute a plurality of entities working in coordination to provide the specified functionality of a payment processor.

FIG. 2 shows various hardware features of auction server 110. Auction server 110 includes a CPU 111, memory 112 (such as RAM), data storage 113 (such as a hard disk or solid state drive), and a network interface 114.

CPU 111 processes instructions stored in memory 112, in accordance with operating system and auction software stored in data storage 113 for execution by auction server 110. Data storage 113 also stores data for the auction software, such as information relating to auction listings, bids, and bidders.

Network interface 114 enables auction server 110 to communicate with network 120 over network link 121.

FIG. 3 shows the software modules for the auction software executed on auction server 110. Auction server 110 executes a bidding module 310. Bidding module 310 may include software for conducting an auction, such as accepting an auction listing, accepting bids, and notifying corresponding parties of the auction status and activities. Bidding module 310 may optionally coordinate the exchange of items and funds between the final parties.

Auction server 110 also executes an EPS interface module 320. EPS interface module 320 exchanges data with EPS server 150 using network interface 114.

Auction server 110 further executes a user authentication module 330. User authentication module 330 authenticates the operators of auction-listing submission devices 130 and bid submission devices 140. User authentication module 330 thus confirms the identity of the parties involved in an auction.

FIG. 4 shows various hardware features of EPS server 150. EPS server 150 includes a CPU 410, memory 420 (such as RAM), data storage 430 (such as a hard disk or solid state drive), and a network interface 440.

CPU 410 processes instructions stored in memory 420, in accordance with operating system and auction software stored in data storage 430 for execution by EPS server 150. Data storage 430 also stores data for the escrow payment software, such as information relating to auction listings, bids, and bidders.

Network interface 440 enables EPS server 150 to communicate with network 120 over network link 122.

FIG. 5 shows the software modules for the software executed on EPS server 150. EPS server 150 executes an EPS execution module 510. EPS execution module 510 may include software for maintaining auction transaction information, such as buyer/seller information, delivery tracking and confirmation, and a timer for a buyer to inspect received auction goods.

EPS server 150 also executes an EPS account management module 520. EPS account management module 520 manages the banking information for buyers and sellers, ensuring that these participants have valid banking information and comply with KYC checks.

EPS server 150 further executes an auction server interface 530 and a payment processor interface 540. Auction server interface 530 exchanges data with auction server 110 using network interface 440, while payment processor interface 540 exchanges data with payment processor server 160 using network interface 440.

FIG. 6 shows various hardware features of payment processor server 160. Payment processor server 160 includes a CPU 610, memory 620 (such as RAM), data storage 630 (such as a hard disk or solid state drive), and a network interface 640.

CPU 610 processes instructions stored in memory 620, in accordance with operating system and auction software stored in data storage 630 for execution by payment processor server 160. Data storage 630 also stores each participant's bank account information, KYC check compliance information, and timer information for buyers to inspect received goods.

Network interface 640 enables payment processor server 160 to communicate with network 120 over network link 123.

FIG. 7 shows the software modules for the software executed on payment processor server 160. Payment processor server 160 executes an account management module 710. Account management module 710 may include software for receiving and processing funds transfer requests, sub-account creation and termination requests, KYC check requests, and other financial requests, and for generating notices to these requests.

Payment processor server 160 also executes a sub-account management module 720. Sub-account management module 720 manages sub-accounts, including the creation and termination of individual sub-accounts, and information relating to each sub-account. It will appreciated that a sub-account may be any variety of financial account within the payment processor, including, for example, an account bearing an ACH identification number, a logical account only accessible internally within the payment processor, or any other electronic record which uniquely identifies a transaction, funds corresponding to the transaction, and the available balance for that transaction.

Payment processor server 160 also executes a funds transfer module 730. Funds transfer module 730 processes requests to transfer funds to, or from, a sub-account to a general account, along with requests to transfer funds between internal accounts and external or third-party accounts. For example, transfers between ACH accounts may be processed via the ACH network, while transfers between internal accounts may involve the updating of the corresponding logical account information or electronic records.

Payment processor server 160 additionally executes an EPS server interface 740. EPS server interface 530 exchanges data with EPS server 150 using network interface 640.

FIG. 8 shows an example of an organization structure that may be used with the invention. The organization structure includes the auction server, EPS, and the payment processor.

As seen in FIG. 8, an auction service is associated with entities such as government or private business entities. Each entity may be associated with various organizations, or levels of organizations. For example, the organization may include the various departments (e.g., business, human resources) and groups associated with the organization. Each department and/or group may participate in the auction service to purchase and/or sell goods or services.

An auction buy is involved with a specific buyer within an organization of the purchasing entity and a specific seller within an organization of a selling entity. Each organization and entity sends information to, and receives information from, EPS. This transfer of information may be coordinated directly with the organization, or may first be channeled via a higher level of the entity's organizational structure. For instance, the system may only permit registration of organizations that possess a tax identification number (e.g., Employer Identification Number (EIN)). In such an instance, if the organization is only a logical unit of a parent entity, the organization may only participate as a representative of its parent entity. However, it will be appreciated that the system may alternatively permit any organization or group to participate.

The payment processor could be a global entity capable of communicating with EPS on a global scale. The payment processor includes a payment entity, which receives information from a line of business division. The line of business division coordinates the lines of business between the various organizations utilizing the auction service. The line of business division in turn receives individual order information from the buyers and sellers affiliated with these organizations.

FIGS. 9A-9C show a method of operating the auction server 110, EPS server 150, and payment processor server 160 in accordance with a first embodiment of the invention. FIG. 10 is a graphical representation of the execution of the method of FIGS. 9A-9C, with the respective steps performed by the buyer, the seller, EPS, an online business (such as the auction service), and the payment processor. The steps are described with respect to a reverse auction. However, it will be appreciated that these steps are applicable to a forward auction or a transaction other than an auction.

In step S901, the auction server 110 captures buyer and/or seller banking information. This may include the banking information for all potential buyers and sellers. That is, in a forward auction, the auction server 110 may capture the banking information for the seller and for all buyers desiring to participate in the auction. In a reverse auction, the auction server 110 may capture the banking information for the buyer and for all sellers desiring to participate in the auction. Alternatively, it will be appreciated that in a forward auction, only the seller's bank account information may be necessary at the start of the auction, and that in a reverse auction, only the buyer's bank account information may be necessary at the start of the auction. As such, it will be appreciated that the auction server 110 may initially capture only the buyer's bank account, and defer the capture of the winning seller's bank account information until after the auction has concluded. In such an instance, only the winning seller's bank account information is needed, and the remaining sellers' bank account information would not be captured. The auction server 110 forwards the banking information to the EPS server 150, which in turn forwards such information to the payment processor server 160.

In step S902, the payment processor server 160 conducts validation and security checks on the received banking information. The payment processor server 160 transmits the results of these checks to the EPS server 150, which in turn forwards the information to the auction server 110. It will be appreciated that if both the buyer and potential sellers' bank account information is processed, the auction server 110 may be configured so as to prevent sellers and buyers from participating in an auction until their banking information has been approved. Alternatively, if only the buyer's bank account information is processed, the auction server 110 may be configured merely to prevent the buyer from participating in the auction until the buyer's banking information has been approved. It will be appreciated that the EPS server 150 may itself be capable of conducting the validation and security checks, and in such an instance, the EPS server 150 will perform such checks without involving the payment processor server 160.

In step S903, the auction server 110 conducts the auction. This step includes receiving bids from bidders, notifying parties of the status of the auction, and calculating leading bids.

In step S904, the auction server 110 awards an auction buy to a winning seller. The winning seller held the leading bid upon expiration of the auction. In circumstances where price is the sole metric for the ordering of bids, the winning seller's bid price was below that of competing bids. Alternatively, where additional or other metrics are used, the seller's offer was determined to be most advantageous over any competing bids. If the auction server 110 has not already captured the seller's banking information in step S901, the auction server 110 captures such information here in step S904. In such an instance, the auction server 110 may separately request that the payment processor server 160 conduct validation and security checks on the seller's banking information, and may temporarily suspend activity until the seller's banking information has been approved.

In step S905, the auction server 110 transmits the winning bid information to the EPS server 150.

In step S906, the EPS server 150 sends an instruction to the payment processor server 160 with information regarding the buyer and the auction. This information includes at least the buyer's bank account information, along with the amounts of the auction payment and fees for debit from the buyer's account. Alternatively, if the buyer's bank account information is pre-stored and is identifiable by the EPS server 150 and the payment processor server 160 using another identifier, that other identifier may be used instead.

In step S907, the payment processor server 160 creates a unique and discrete financial account affiliated with the auction. This unique financial account is also referred to herein as a sub-account. This sub-account will subsequently store the funds debited from the buyer's bank account, and is specific to the auction transaction. That is, this sub-account is different from all remaining sub-accounts, even in the case where the seller of a first auction (or other transaction) is the same as the seller of a second auction (or other transaction), or where the buyer of a first auction (or other transaction) is the same as the buyer of a second auction (or other transaction).

In step S908, the payment processor server 160 initiates a debit from the buyer's bank account, for the amount of the auction and the fees, according to the information received in step S906. The payment processor server 160 stores these debited funds in the sub-account created in step S907. It will be appreciated that this debit may occur in at least one of two different techniques. First, the payment processor server 160 may transfer received funds directly into the sub-account. Alternatively, the payment processor server 160 may transfer received funds into a general account, and then immediately transfer these funds into the sub-account. The latter method may be preferable so as to conceal the sub-account information from outside financial institutions such as the buyer's bank. The latter method may also be preferable when sub-accounts are logical accounts or electronic records. In such an instance, the payment processor server 160 may perform the first transfer from the buyer's bank account into a general account via, for example, ACH, while performing the second transfer from the general account into the sub-account via an updating of the appropriate logical account or electronic record. The payment processor server 160 may notify the EPS server 150 once the debit has been completed and the funds are stored in the sub-account.

In step S909, the EPS server 150 sends a notice to the auction server 110 that the debit has been completed.

In step S910, the auction server 110 sends a notice to the seller to ship the auction goods to the buyer.

In step S911, the seller employs a shipping service to ship the auction goods to the buyer.

In step S912, the shipping service delivers the auction goods to the buyer.

In step S913, the seller provides proof of delivery to the auction server 110.

In step S914, the auction server 110 transmits the seller's proof of delivery to the EPS server 150.

In step S915, the EPS server 150 sends a request to the auction server 110 to confirm with the buyer that the auction goods were delivered.

In step S916, the auction server 110 sends a notice to the buyer, requesting that the buyer confirm delivery of the auction goods.

In step S917, the buyer confirms the receipt of the auction goods, by responding to the notice sent by the auction server 110 in step S915.

In step S918, the EPS server 150 starts a timer according to a predetermined time period. The predetermined time period is the period provided to the buyer to inspect the delivered auction goods and raise an objection as to the shipment. For instance, the buyer may object that certain auction goods are missing from the shipment. Or, the buyer may object that the delivered goods are defective or inconsistent with a description of these goods provided by the seller during the auction.

In step S919, the EPS server 150 awaits an acceptance or an objection from the buyer. If the buyer accepts the goods, the EPS server 150 proceeds to step S920. If the buyer objects to the goods, the EPS server 150 proceeds to step S921. If the buyer has not provided either an acceptance or an objection, the EPS server 150 proceeds to step S922.

In step S920, a buyer acceptance causes the auction server 110 to transmit such acceptance information to the EPS server 150, and the EPS server 150 receives such information.

In step S921, an objection lodged by the buyer as to the auction goods causes a dispute resolution proceeding and/or an arbitration proceeding to be commenced to resolve the dispute. Meanwhile, the payment processor server 160 maintains the funds stored in the sub-account pending a dispute resolution or an arbitration decision. It will be appreciated that the buyer or seller may initiate dispute resolution and/or arbitration via any acceptable method. For instance, the buyer may initiate the dispute resolution and/or arbitration via the auction server 110, which in turn notifies the EPS server 150 of this status. Alternatively, the buyer may initiate the dispute resolution and/or arbitration directly via the EPS server 150 or through any other means.

In step S922, the EPS server 150 determines whether the timer set in step S918 has expired. If the timer has not expired, the EPS server 150 returns to step S919. If the timer has expired, the EPS server 150 proceeds to step S923.

It will be appreciated that steps S918-S922 may be optional steps in accordance with a desired operation of the system, and that the system may be operated such that delivery confirmation by the buyer and/or seller is a sufficient condition for disbursement of funds. In step S923, the EPS server 150 sends a credit instruction to the payment processor server 160 to disburse the funds in the sub-account.

In step S924, the payment processor server 160 initiates a disbursement of funds to the seller's bank account. These funds represent the payment for the auction goods, and customarily will equal the amount debited in step S908, less any fees that the auction service, the escrow payment service, and/or the payment processor deducts for its contributed services in the transaction. The disbursement may occur in a similar manner to the transfer(s) in step S908. That is, the payment processor server 160 may transfer the funds directly from the sub-account to the seller's bank account. Alternatively, the payment processor server 160 may transfer the funds into the general account, and then immediately transfer these funds into the seller's bank account. The latter method may be preferable so as to conceal the sub-account information from outside financial institutions such as the seller's bank. The latter method may also be preferable when sub-accounts are logical accounts or electronic records. In such an instance, the payment processor server 160 may perform the first transfer from the sub-account account into the general account via an updating of the appropriate logical account or electronic record, while performing the second transfer from the general account into the seller's bank account via, for example, ACH.

In step S925, the payment processor server 160 initiates a disbursement of funds to the auction service's bank account for any fees associated with the auction service, and/or initiates a disbursement of funds to EPS's bank account for any fees associated with its escrow services. The payment processor server 160 may also disburse to itself the fees associated with its own services. These disbursement(s) may occur in the same manner as described above with respect to step S924, or alternatively may occur via any other transfer methodology established between the payment processor and the auction service and/or EPS.

At this stage, the balance of the sub-account should be zero. In Step S926, the payment processor server 160 closes the sub-account.

It will be appreciated that the auction transaction may alternatively or additionally involve services or other contractual obligations instead of goods, and the steps described in FIGS. 9A-9C may be modified as appropriate for confirming the receipt of such services or contractual obligations. For instance, if the auction involves a service or other contractual obligation, steps S910-S917 may be skipped and steps S918-S922 may alternatively correspond to the acceptance of the service or contractual obligation. Of course, even with goods, any type of condition may be alternatively used to trigger a timer and/or the disbursement of funds. Examples include, but are not limited to, shipping, tracking, delivery confirmation, and delivery & inspection clocks.

It will further be appreciated that EPS server 150 may alternatively have the ability to create, administer, and terminate sub-accounts, instead of payment processor server 160. For instance, EPS server 150 may incorporate electronic records which uniquely identify each transaction and funds corresponding to the transaction, and the available balance for that transaction. In such an instance, payment processor server 160 may operate the transfers between external accounts (e.g., ACH), while EPS server 150 provides the functionality for the administration of sub-accounts.

It will even further be appreciated that the debit in steps S906-S908 is not limited to a single buyer bank account, but may alternatively constitute multiple debits from multiple accounts affiliated with the buyer and/or an associate of the buyer. That is, the sub-account may be funded by multiple funding sources. Similarly, it will be appreciated that the disbursement in steps S923 and S924 is not limited to a single seller bank account, but may alternatively constitute multiple credits to multiple accounts affiliated with the seller and/or an associate of the seller. That is, the sub-account funds may be disbursed to multiple funding recipients.

FIG. 11 depicts various banking accounts that may be involved during the operation of the invention. As seen in FIG. 11, a payment processor includes a general escrow account 1100. The general escrow account 1100 is used to facilitate the transfer of funds between the payment processor and external banks. For instance, the payment processor may incorporate a sub-account structure which lacks direct ACH account access. In this case, the sub-accounts may simply be logical accounts managed by the payment processor. Fund transfers may then be accomplished by a combination of an internal transfer between the general escrow account 1100 and a sub-account, and a debit or credit between the general escrow account 1100 and an external account.

Three payment processor sub-accounts 1110-1112 are shown in FIG. 11. Sub-account 1110 is designated for auction #518473, a transaction between seller A and buyer X. Sub-account 1111 is designated for auction #518474, a transaction between seller A and buyer Y. Sub-account 1112 is designated for auction #518937, a transaction between seller B and buyer X.

Four external bank accounts 1120-1123 are also shown in FIG. 11. Bank account 1120 is located within bank #1, and belongs to seller A. Bank account 1121 is located within bank #2, and belongs to seller B. Bank account 1122 is located within bank #3, and belongs to buyer X. Bank account 1123 is located within bank #4, and belongs to buyer Y.

Funds are transferred via an ACH or wire transfer network 1130 connecting the banks #1-#4 and the payment processor. Alternatively, it will be appreciated that any other connection allowing for financial transfer may be used instead of, or in addition to, the ACH or wire transfer network.

FIG. 12 shows a first method of processing fund transfers which incorporates a real-time approach and which may be utilized with the invention including steps S905-S908, S920, and S923-S926. Using this method, fund transfers are initiated immediately upon receipt.

In this method, steps S1201-S1206 illustrate the debiting of the buyer's funds, while steps S1207-S1212 illustrate the disbursement of funds to the seller.

In step S1201, the auction server 110 transmits winning bid information of an auction to the EPS server 150. Step S1201 corresponds to step S905 in FIG. 9A.

In step S1202, the auction server 110 immediately processes the winning bid information, generates a request to debit the funds from the buyer's account, and immediately sends the request to the payment processor server 160. Step S1202 corresponds to step S906 in FIG. 9A.

In step S1203, the payment processor server 160 receives the request, and validates the buyer's bank account. This validation may include internal verifications such as a check on whether a line of business (LOB) exists. In step S1204, upon validation of the request, the payment processor server 160 creates a sub-account for the transaction. Steps S1203 and S1204 correspond to step S907 in FIG. 9A.

As seen in FIG. 12, the results of these verifications are immediately returned to the EPS server 150. The EPS server 150 receives this information and consumes and reconciles the validation information, either instantaneously or periodically (e.g., every few hours). If the debit request fails validation, the EPS server 150 notifies the auction server 110, who in turn notifies the buyer of such failure.

In step S1205, the payment processor server 160 initiates a debit from the buyer's bank account into a general account. In step S1206, the payment processor server 160 transfers the debited funds into the sub-account. Steps S1205 and S1206 correspond to step S908 in FIG. 9A.

As already described above, the payment processor server 160 preferably debits the funds into a general account and then transfers the funds into the sub-account. As previously mentioned, the latter method may be preferable when sub-accounts are logical accounts or electronic records. In such an instance, the payment processor server 160 may perform the first transfer from the buyer's bank account into a general account via, for example, ACH, while performing the second transfer from the general account into the sub-account via an updating of the appropriate logical account or electronic record. However, it will be appreciated that alternatively the payment processor server 160 may directly debit the funds into the sub-account. In this case, steps S1205 and S1206 may be combined into such a single step.

In step S1207, the auction server 110 receives a notification of the buyer's acceptance of the goods, and provides this information to the EPS server 150. Step S1207 corresponds to step S920 in FIG. 9C.

In step S1208, the EPS server 150, immediately after receiving the notification from the auction server 110, sends a credit instruction to the payment processor server 160. Step S1208 corresponds to step S923 in FIG. 9C.

In step S1209, the payment processor server 160 receives the request, and validates the seller's bank account. This validation may include internal verifications such as a check on whether a LOB exists, along with whether sufficient funds exist for the request.

As seen in FIG. 12, the results of these verifications are immediately returned to the EPS server 150. If the credit request fails validation, the EPS server 150 notifies the auction server 110, who in turn notifies the seller of such failure.

In step S1210, upon validation of the request, the payment processor server 160 transfers the appropriate funds from the sub-account to the general account, and in step S1211, initiates a credit from the general account to the seller's bank account. Steps S1209-S1211 correspond to step S924 in FIG. 9C. If sub-accounts are logical accounts or electronic records, the payment processor server 160 may perform the first transfer from the sub-account account into the general account via an updating of the appropriate logical account or electronic record, while performing the second transfer from the general account into the seller's bank account via, for example, ACH.

As with the debit process, it will be appreciated that alternatively the payment processor server 160 may directly credit the funds from the sub-account to the seller's bank account. In this case, steps S1210 and S1211 may be combined into such a single step.

It will also be appreciated that steps analogous to steps S1210 and S1211 may also be performed to initiate the disbursement of funds for payment of auction, escrow, and/or other fees, which corresponds to step S925 in FIG. 9C.

In step S1212, the payment processor server closes the sub-account if all fund transfers for the auction have been completed. Step S1212 corresponds to step S926 in FIG. 9C.

As described above, the real-time processing method involves the immediate processing of sub-account activity, and the transfers of funds. Debit and credit transactions are processed immediately, and the results of the transactions are immediately returned to the EPS server 150 and/or the auction server 110.

The benefits of using this real-time processing method include a quick validation, so that any requests that fail the validation can promptly be corrected and re-submitted. Effectively, auction participants are able to check the real-time status of their initial validation of their payment request. However, real-time processing is less efficient and involves increased overhead. Moreover, as validated requests are immediately processed, any modifications in a request cannot be processed until the original request is first completed.

FIG. 13 shows a second method of processing fund transfers which incorporates a batch approach and which may be utilized with the invention including steps S905-S908, S920, and S923-S926. Using this method, fund transfers are initiated at the close of each business day as a daily batch.

In this method, steps S1302, S1303, and S1307-S1310 illustrate the debiting of buyer's funds, while steps S1304, S1305, and S1311-S1314 illustrate the disbursement of funds to the seller.

In step S1301, at the beginning of a business day, the EPS server 150 creates a blank list of transactions to be performed by the payment processor server 160, including debit and credit requests and sub-account activity.

In step S1302, the auction server 110 transmits winning bid information of a first auction (“auction #1”) to the EPS server 150. Step S1302 corresponds to step S905 in FIG. 9A.

In step S1303, the EPS server 150 adds a debit request to the batch list, but does not yet transmit any information to the payment processor server 160.

In step S1304, the auction server 110 receives a notification of the buyer's acceptance of the goods in a second auction (“auction #2”), and provides this information to the EPS server 150. Step S1304 corresponds to step S920 in FIG. 9C.

In step S1305, the EPS server 150 adds a credit request to the batch list, but does not yet transmit any information to the payment processor server 160.

Based on shipping and inspection times, goods are ordinarily not delivered and accepted until days after winning auction information is transmitted and buyer funds are debited. As such, steps S1304, S1305, and S1311-S1314 are described as relating to a second auction for a disbursement transaction in the second auction that is conducted on the same day as the debit in the first auction. However, it will be appreciated that steps S1304, S1305, and S1311-S1314 are applicable to the first auction if the goods are delivered, inspected, and accepted on the same day.

In step S1306, at the close of the business day, the EPS server 150 sends the batch list to the payment processor server 160. The combination of steps S1303 and S1306 corresponds to step S905 in FIG. 9A, and the combination of steps S1305 and S1306 corresponds to step S923 in FIG. 9C.

In step S1307, the payment processor server 160 validates the buyer's bank account in auction #1. This validation may include internal verifications such as a check on whether a LOB exists. In step S1308, upon validation of the request, the payment processor server 160 creates a sub-account for the transaction. Steps S1307 and S1308 correspond to step S907 in FIG. 9A.

As seen in FIG. 13, the results of these verifications are then returned to the EPS server 150 at the close of the business day. The EPS server 150 receives this information, and consumes and reconciles the aggregated information.

In step S1309, the payment processor server 160 initiates a debit from the buyer's bank account into a general account. In step S1310, the payment processor server 160 transfers the debited funds into the sub-account. Steps S1309 and S1310 correspond to step S908 in FIG. 9A.

As already described above, the payment processor server 160 preferably debits the funds into a general account and then transfers the funds into the sub-account. As previously mentioned, this method may be preferable when sub-accounts are logical accounts or electronic records. In such an instance, the payment processor server 160 may perform the first transfer from the buyer's bank account into a general account via, for example, ACH, while performing the second transfer from the general account into the sub-account via an updating of the appropriate logical account or electronic record. However, it will be appreciated that alternatively the payment processor server 160 may directly debit the funds into the sub-account. In this case, steps S1309 and S1310 may be combined into such a single step.

In step S1311, the payment processor server 160 validates the seller's bank account in auction #2. This validation may include internal verifications such as a check on whether a LOB exists, along with whether sufficient funds exist for the request.

As seen in FIG. 13, the results of these verifications are returned to the EPS server 150 at the close of the business day. The EPS server 150 receives this information, and consumes and reconciles the aggregated information. If a debit or credit request fails validation, the EPS server 150 notifies the auction server 110, who in turn notifies the respective party of such failure.

In step S1312, upon validation of the request, the payment processor server 160 transfers the appropriate funds from the sub-account to the general account, and in step S1313, initiates a credit from the general account to the seller's bank account. Steps S1311-S1313 correspond to step S924 in FIG. 9C. If sub-accounts are logical accounts or electronic records, the payment processor server 160 may perform the first transfer from the sub-account account into the general account via an updating of the appropriate logical account or electronic record, while performing the second transfer from the general account into the seller's bank account via, for example, ACH.

As with the debit process, it will be appreciated that alternatively the payment processor server 160 may directly credit the funds from the sub-account to the seller's bank account. In this case, steps S1312 and S1313 may be combined into such a single step.

It will also be appreciated that steps analogous to steps S1312 and S1313 may also be performed to initiate the disbursement of funds for payment of auction, escrow, and/or other fees, which corresponds to step S925 in FIG. 9C.

In step S1314, the payment processor server closes the sub-account if all fund transfers for the auction have been completed. Step S1314 corresponds to step S926 in FIG. 9C.

As described above, the batch processing method involves the holding of sub-account activity and fund transfer requests until the end of the business day.

The benefits of using this batch processing method include the reduction of overhead and more efficient processing of transfers. Additionally, modifications to requests may be applied throughout the business day, such that only the final modified request is processed at the end of the day. However, validations are not conducted until the end of the day, and any transaction that fails the validation is delayed until at least the next business day. As a result, the transfer of funds from buyer to seller may be delayed.

It will be appreciated that any period other than a business day may alternatively be used, the period is not limited to even a daily interval, and that even when a daily interval is selected, the days may also include weekends and/or holidays.

It will further be appreciated that while the method of FIG. 13 describes a single batch list containing both debit and credit requests, separate batch lists for debit requests and credit requests, or any other division of requests are also within the scope of the invention.

FIG. 14 shows a third method of processing fund transfers which incorporates a hybrid real-time/batch approach and which may be utilized with the invention including steps S905-S908, S920, and S923-S926. Using this method, validations are immediately performed on debit and credit requests, but the requests are “held” until the end of the business day when they are “released” for actual processing.

In this method, steps S1402-S1405 and S1411-S1413 illustrate the debiting of buyer's funds, while steps S1406-S1409 and S1414-S1416 illustrate the disbursement of funds to the seller.

In step S1401, at the beginning of a business day, the EPS server 150 creates a blank list of requests to be released by the payment processor server 160, including debit and credit requests and sub-account activity.

In step S1402, the auction server 110 transmits winning bid information of a first auction (“auction #1”) to the EPS server 150. Step S1402 corresponds to step S905 in FIG. 9A.

In step S1403, the auction server 110 immediately sends a request to the payment processor server 160 to validate the debit request.

In step S1404, the payment processor server 160 receives the request, and validates the buyer's bank account. This validation may include internal verifications such as a check on whether a LOB exists.

As seen in FIG. 14, the results of these verifications are immediately returned to the EPS server 150.

In step S1405, the EPS server 150 receives the validation information. If the debit request is successfully validated, the EPS server 150 adds the debit request to the release list. By adding the debit request to the release list, the transaction is placed on hold until its release at the close of the business day. The EPS server 150 also consumes and reconciles the validation information, either instantaneously or periodically (e.g., every few hours). If the debit request fails validation, the EPS server 150 notifies the auction server 110, which in turn notifies the buyer of such failure.

In step S1406, the auction server 110 receives a notification of the buyer's acceptance of the goods in a second auction (“auction #2”), and provides this information to the EPS server 150. Step S1406 corresponds to step S920 in FIG. 9C.

In step S1407, the auction server 110 immediately sends a request to the payment processor server 160 to validate the credit request.

In step S1408, the payment processor server 160 receives the request, and validates the seller's bank account. This validation may include internal verifications such as a check on whether a LOB exists, along with whether sufficient funds exist for the request.

As seen in FIG. 14, the results of these verifications are immediately returned to the EPS server 150.

In step S1409, the EPS server 150 receives the validation information. If the credit request is successfully validated, the EPS server 150 adds the credit request to the release list. By adding the credit request to the release list, the transaction is placed on hold until its release at the close of the business day. The EPS server 150 also consumes and reconciles the validation information, either instantaneously or periodically (e.g., every few hours). If the credit request fails validation, the EPS server 150 notifies the auction server 110, which in turn notifies the seller of such failure.

Based on shipping and inspection times, goods are ordinarily not delivered and accepted until days after winning auction information is transmitted and buyer funds are debited. As such, steps S1406, S1407, S1409, and S1414-S1416 are described as relating to a second auction for a disbursement transaction in the second auction that is conducted on the same day as the debit in the first auction. However, it will be appreciated that steps S1406, S1407, S1409, and S1414-S1416 are applicable to the first auction if the goods are delivered, inspected, and accepted on the same day.

In step S1410, at the close of the business day, the EPS server 150 sends the release list to the payment processor server 160. The combination of steps S1405 and S1410 corresponds to step S905 in FIG. 9A, and the combination of steps S1409 and S1410 corresponds to step S923 in FIG. 9C.

In step S1411, the payment processor server 160 creates a sub-account for the transaction. Step S1404 and S1411 correspond to step S907 in FIG. 9A.

In step S1412, the payment processor server 160 initiates a debit from the buyer's bank account into a general account. In step S1413, the payment processor server 160 transfers the debited funds into the sub-account. Steps S1412 and S1413 correspond to step S908 in FIG. 9A.

As already described above, the payment processor server 160 preferably debits the funds into a general account and then transfers the funds into the sub-account. As previously mentioned, this method may be preferable when sub-accounts are logical accounts or electronic records. In such an instance, the payment processor server 160 may perform the first transfer from the buyer's bank account into a general account via, for example, ACH, while performing the second transfer from the general account into the sub-account via an updating of the appropriate logical account or electronic record. However, it will be appreciated that alternatively the payment processor server 160 may directly debit the funds into the sub-account. In this case, steps S1412 and S1413 may be combined into such a single step.

In step S1414, the payment processor server 160 transfers the appropriate funds from the sub-account to the general account, and in step S1415, initiates a credit from the general account to the seller's bank account. Steps S1408, S1414, and S1415 correspond to step S924 in FIG. 9C. If sub-accounts are logical accounts or electronic records, the payment processor server 160 may perform the first transfer from the sub-account account into the general account via an updating of the appropriate logical account or electronic record, while performing the second transfer from the general account into the seller's bank account via, for example, ACH.

As with the debit process, it will be appreciated that alternatively the payment processor server 160 may directly credit the funds from the sub-account to the seller's bank account. In this case, steps S1414 and S1415 may be combined into such a single step.

It will also be appreciated that steps analogous to steps S1414 and S1415 may also be performed to initiate the disbursement of funds for payment of auction, escrow, and/or other fees, which corresponds to step S925 in FIG. 9C.

In step S1416, the payment processor server closes the sub-account if all fund transfers for the auction have been completed. Step S1416 corresponds to step S926 in FIG. 9C.

As with the batch method of FIG. 13, it will be appreciated that any period other than a business day may alternatively be used for a release period, the period is not limited to even a daily interval, and that even when a daily interval is selected, the days may also include weekends and/or holidays.

It will further be appreciated that while the method of FIG. 14 describes a single release list containing both debit and credit requests, separate release lists for debit requests and credit requests, or any other division of requests are also within the scope of the invention.

In the methods described in FIGS. 12-14, it will be appreciated that a credit request may be alternatively triggered by the expiration of the timer according to step S922, instead of by a notification of an acceptance of goods.

FIG. 15 shows an example release file 1500 that may be used in connection with the hybrid real-time/batch approach described in FIG. 14 in storing the release list. The example references the transactions described in FIG. 11.

The first entry in release file 1500 corresponds to a release of a debit request for auction #518473. This request instructs the payment processor server 160 to create Sub-account #1, debit $5,000 from buyer X's bank account via ACH pull into its general account, and transfer the $5,000 into Sub-account #1.

The second entry in release file 1500 corresponds to a release of a debit request for auction #518474. This request instructs the payment processor server 160 to create Sub-account #2, debit $7,000 from buyer Y's bank account via ACH pull into its general account, and transfer the $7,000 into Sub-account #2.

The third entry in release file 1500 corresponds to a release of a credit request for auction #518937. This request instructs the payment processor server 160 to disburse $1000 from Sub-account #3 into seller B's bank account.

The fourth entry in release file 1500 corresponds to a release of another credit request for auction #518937. This request instructs the payment processor server 160 to disburse $100 from Sub-account #3 into the auction server's accounts-receivable bank account, as payment of service fees for the auction.

It will be appreciated that other debit and credit transactions involving buyer X, buyer Y, seller A, seller B, the auction service, EPS, and other entities may exist, but in this example, may be requested on a day other than this particular business day.

It will also be appreciated that the requests may already be stored on the payment processor server 160 during the validation process, and the release file 1500 may simply refer to an identification of the request stored on the payment processor server 160.

The invention thus far has been described with respect with an auction, and specifically a reverse auction. However, the invention is not limited thereto.

FIG. 16 shows an online system 1600 that may carry out features in accordance with another aspect of the present invention. The same component elements as those already described are designated by the same reference numerals and their description is omitted and different operations will be described here.

This aspect of the invention differs from the first aspect of the invention, in that an online business 1610 is provided in the system 1600 instead of the auction server 110. Online business 1610 is connected to network 120 via a network link 1621. It will be appreciated that online business 1610, EPS server 150, and payment processor server 160 may alternatively be connected through dedicated and/or private network links or other methods of information exchange.

It will be appreciated that online business 1610 may be any service that manages a transaction between a payor and a payee. Examples of transactions include, but are not limited to, auctions, sales of goods and services, contractual obligations, or any other type of transaction. It will also be appreciated that EPS server 150 may be capable of operating with multiple online businesses 1610 (e.g., different transaction/sales/auction web sites).

The system 1600 also includes at least one payee device 1630 and at least one payor device 1640. Payee device 1630 is connected to network 120 via a network link 1631, and payor device 1640 is connected to network 120 via a network link 1641. In a preferred embodiment, payee device 1630 and payor device 1640 are personal computers. However, it will be appreciated that the devices may alternatively include cellular telephones (e.g., smartphones), tablets, terminals, or any other devices capable of submitting electronic information to the system 1600.

Payee device 1630 is operated by a payee desiring to receive a payment from a payor. The payee may be an individual or other entity (e.g., corporate or government).

Payor device 1640 is operated by the payor desiring to provide the payment to the payee. The payor may be an individual or other entity (e.g., corporate or government).

It will be understood that system 1600 may include multiple payee devices 1630 and multiple payor devices 1640, each connected to network 120. It will also be appreciated that any payee device 1630 and/or payor device 1640 may communicate with the online business 1610 via a web browser, dedicated software, text messaging, or any other form of data communication.

FIG. 17 shows various hardware features of online business 1610. Online business 1610 includes a CPU 1711, memory 1712 (such as RAM), data storage 1713 (such as a hard disk or solid state drive), and a network interface 1714.

CPU 1711 processes instructions stored in memory 1712, in accordance with operating system and software stored in data storage 1713 for execution by online business 1610. Data storage 1713 also stores data for the client software for executing transactions.

Network interface 1714 enables online business 1610 to communicate with network 120 over network link 1621.

FIG. 18 shows the software modules for software executed on online business 1610. Online business 1610 executes a transaction processing module 1810. Transaction processing module 1810 may include software for conducting a transaction, such as accepting a transaction request, initiating a transaction, finalizing a transaction, and notifying corresponding parties of the transaction status and activities. Transaction processing module 1810 may optionally coordinate the exchange of items and funds between the payor and payee.

Online business 1610 also executes an EPS interface module 1820. EPS interface module 1820 exchanges data with EPS server 150 using network interface 1714.

Online business 1610 further executes a user authentication module 1830. User authentication module 1830 authenticates the operators of payee devices 1630 and payor devices 1640. User authentication module 1830 thus confirms the identity of the payees and payors.

FIGS. 19A-19C show a method of operating the online business 1610, EPS server 150, and payment processor server 160 in accordance with a second embodiment of the invention. FIG. 10 still graphically represents the execution of the method of FIGS. 19A-19C, with the respective steps performed by the payor, the payee, EPS, the online business, and the payment processor.

In step S1901, the online business 1610 captures payor and payee banking information. The online business 1610 forwards the banking information to the EPS server 150, which in turn forwards such information to the payment processor server 160.

In step S1902, the payment processor server 160 conducts validation and security checks on the received banking information. The payment processor server 160 transmits the results of these checks to the EPS server 150, which in turn forwards the information to the online business 1610. It will be appreciated that the online business 1610 may be configured so as to prevent payors and payees from participating in a transaction until their banking information has been approved. It will be appreciated that the EPS server 150 may itself be capable of conducting the validation and security checks, and in such an instance, the EPS server 150 will perform such checks without involving the payment processor server 160.

In step S1903, the online business 1610 initiates the transaction. It will be appreciated that the particular features of this step will depend on the specific transaction involved.

In step S1904, the online business 1610 finalizes the transaction.

In step S1905, the online business 1610 transmits the transaction information to the EPS server 150.

In step S1906, the EPS server 150 sends an instruction to the payment processor server 160 with information regarding the payor and the transaction. This information includes at least the payor's bank account information, along with the amounts of the transaction payment and fees for debit from the payor's account. Alternatively, if the payor's bank account information is pre-stored and is identifiable by the EPS server 150 and the payment processor server 160 using another identifier, that other identifier may be used instead.

In step S1907, the payment processor server 160 creates a unique and discrete financial account affiliated with the transaction. This unique financial account is also referred to herein as a sub-account. This sub-account will subsequently store the funds debited from the payor's bank account, and is specific to the transaction. That is, this sub-account is different from all remaining sub-accounts, even in the case where the payee of a first transaction is the same as the payee of a second transaction, or where the payor of a first transaction is the same as the payor of a second transaction.

In step S1908, the payment processor server 160 initiates a debit from the payor's bank account, for the amount of the transaction and the fees, according to the information received in step S1906. The payment processor server 160 stores these debited funds in the sub-account created in step S1907. It will be appreciated that this debit may occur in at least one of two different techniques. First, the payment processor server 160 may transfer received funds directly into the sub-account. Alternatively, the payment processor server 160 may transfer received funds into a general account, and then immediately transfer these funds into the sub-account. The latter method may be preferable so as to conceal the sub-account information from outside financial institutions such as the payor's bank. The latter method may also be preferable when sub-accounts are logical accounts or electronic records. In such an instance, the payment processor server 160 may perform the first transfer from the payor's bank account into a general account via, for example, ACH, while performing the second transfer from the general account into the sub-account via an updating of the appropriate logical account or electronic record. The payment processor server 160 may notify the EPS server 150 once the debit has been completed and the funds are stored in the sub-account.

In step S1909, the EPS server 150 sends a notice to the online business 1610 that the debit has been completed.

In step S1910, the online business 1610 sends a notice to the payee to ship the transaction goods to the payor.

In step S1911, the payee employs a shipping service to ship the transaction goods to the payor.

In step S1912, the shipping service delivers the transaction goods to the payor.

In step S1913, the payee provides proof of delivery to the online business 1610.

In step S1914, the online business 1610 transmits the payee's proof of delivery to the EPS server 150.

In step S1915, the EPS server 150 sends a request to the online business 1610 to confirm with the payor that the goods were delivered.

In step S1916, the online business 1610 sends a notice to the payor, requesting that the payor confirm delivery of the goods.

In step S1917, the payor confirms the receipt of the transaction goods, by responding to the notice sent by the online business 1610 in step S1916.

In step S1918, the EPS server 150 starts a timer according to a predetermined time period. The predetermined time period is the period provided to the payor to inspect the delivered goods and raise an objection as to the shipment. For instance, the payor may object that certain transaction goods are missing from the shipment. Or, the payor may object that the delivered goods are defective or inconsistent with a description of these goods provided by the payee during the pendency of the transaction.

In step S1919, the EPS server 150 awaits an acceptance or an objection from the payor. If the payor accepts the goods, the EPS server 150 proceeds to step S1920. If the payor objects to the goods, the EPS server 150 proceeds to step S1921. If the payor has not provided either an acceptance or an objection, the EPS server 150 proceeds to step S1922.

In step S1920, a payor acceptance causes the online business 1610 to transmit such acceptance information to the EPS server 150, and the EPS server 150 receives such information.

In step S1921, an objection lodged by the payor as to the transaction goods causes a dispute resolution proceeding and/or an arbitration proceeding to be commenced to resolve the dispute. Meanwhile, the payment processor server 160 maintains the funds stored in the sub-account pending a dispute resolution or an arbitration decision. It will be appreciated that the payor or payee may initiate dispute resolution and/or arbitration via any acceptable method. For instance, the payor may initiate the dispute resolution and/or arbitration via the online business 1610, which in turn notifies the EPS server 150 of this status. Alternatively, the payor may initiate the dispute resolution and/or arbitration directly via the EPS server 150 or through any other means.

In step S1922, the EPS server 150 determines whether the timer set in step S1918 has expired. If the timer has not expired, the EPS server 150 returns to step S1919. If the timer has expired, the EPS server 150 proceeds to step S1923.

It will be appreciated that steps S1918-S1922 may be optional steps in accordance with a desired operation of the system, and that the system may be operated such that delivery confirmation by the payor and/or payee is a sufficient condition for disbursement of funds.

In step S1923, the EPS server 150 sends a credit instruction to the payment processor server 160 to disburse the funds in the sub-account.

In step S1924, the payment processor server 160 initiates a disbursement of funds to the payee's bank account. These funds represent the payment for the transaction goods, and customarily will equal the amount debited in step S1908, less any fees that the online business, the escrow payment service, and/or the payment processor deducts for its contributed services in the transaction. The disbursement may occur in a similar manner to the transfer(s) in step S1908. That is, the payment processor server 160 may transfer the funds directly from the sub-account to the payee's bank account. Alternatively, the payment processor server 160 may transfer the funds into the general account, and then immediately transfer these funds into the payee's bank account. The latter method may be preferable so as to conceal the sub-account information from outside financial institutions such as the payee's bank. The latter method may also be preferable when sub-accounts are logical accounts or electronic records. In such an instance, the payment processor server 160 may perform the first transfer from the sub-account account into the general account via an updating of the appropriate logical account or electronic record, while performing the second transfer from the general account into the payee's bank account via, for example, ACH.

In step S1925, the payment processor server 160 initiates a disbursement of funds to the online business' bank account for any fees associated with the transaction service, and/or initiates a disbursement of funds to EPS's bank account for any fees associated with its escrow services. The payment processor server 160 may also disburse to itself the fees associated with its own services. These disbursement(s) may occur in the same manner as described above with respect to step S1924, or alternatively may occur via any other transfer methodology established between the payment processor and the online business and/or EPS.

At this stage, the balance of the sub-account should be zero. In Step S1926, the payment processor server 160 closes the sub-account.

It will be appreciated that the transaction may alternatively or additionally involve services or other contractual obligations instead of goods, and the steps described in FIGS. 19A-19C may be modified as appropriate for confirming the receipt of such services or contractual obligations. For instance, if the transaction involves a service or other contractual obligation, steps S1910-S1917 may be skipped and steps S1918-S1922 may alternatively correspond to the acceptance of the service or contractual obligation. Of course, even with goods, any type of condition may be alternatively used to trigger a timer and/or the disbursement of funds. Examples include, but are not limited to, shipping, tracking, delivery confirmation, and delivery & inspection clocks.

It will further be appreciated that EPS server 150 may alternatively have the ability to create, administer, and terminate sub-accounts, instead of payment processor server 160. For instance, EPS server 150 may incorporate electronic records which uniquely identify each transaction and funds corresponding to the transaction, and the available balance for that transaction. In such an instance, payment processor server 160 may operate the transfers between external accounts (e.g., ACH), while EPS server 150 provides the functionality for the administration of sub-accounts.

It will even further be appreciated that the debit in steps S1906-S1908 is not limited to a single payor bank account, but may alternatively constitute multiple debits from multiple accounts affiliated with the payor and/or an associate of the payor. That is, the sub-account may be funded by multiple funding sources. Similarly, it will be appreciated that the disbursement in steps S1923 and S1924 is not limited to a single payee bank account, but may alternatively constitute multiple credits to multiple accounts affiliated with the payee and/or an associate of the payee. That is, the sub-account funds may be disbursed to multiple funding recipients.

It will also be appreciated that debit and credit requests may be processed in real-time, batch, or hybrid real-time/batch as explained above with reference to FIGS. 12-14.

The invention thus far has been described with respect with an auction server or an online business that handles a transaction. However, the invention is not limited thereto.

FIG. 20 shows an online system 2000 that may carry out features in accordance with yet another aspect of the present invention. The same component elements as those already described are designated by the same reference numerals and their description is omitted and different operations will be described here.

This aspect of the invention differs from the first and second aspects of the invention, in that a payee and a payor directly coordinate with EPS server 150 to oversee a transfer of funds, without an intervening entity such as the auction server 110 or the online business 1610. In such an instance, the transaction details may have already been finalized between the payor and the payee, and all that remains is the transfer of payment and corresponding goods, services, or other contractual obligations. It will be understood that the invention may also be used to transfer payment from the payor to the payee without any corresponding obligation by the payee.

The system 2000 also includes at least one payee device 2030 and at least one payor device 2040. Payee device 2030 is connected to network 120 via a network link 2031, and payor device 2040 is connected to network 120 via a network link 2041. In a preferred embodiment, payee device 2030 and payor device 2040 are personal computers. However, it will be appreciated that the devices may alternatively include cellular telephones (e.g., smartphones), tablets, terminals, or any other devices capable of submitting electronic information to the system 2000.

Payee device 2030 is operated by a payee desiring to receive a payment from a payor. The payee may be an individual or other entity (e.g., corporate or government).

Payor device 2040 is operated by the payor desiring to provide the payment to the payee. The payor may be an individual or other entity (e.g., corporate or government).

It will be understood that system 2000 may include multiple payee devices 2030 and multiple payor devices 2040, each connected to network 120. It will also be appreciated that any payee device 2030 and/or payor device 2040 may communicate with the EPS server 150 via a web browser, dedicated software, text messaging, or any other form of data communication.

FIGS. 21A-21B show a method of operating the EPS server 150 and payment processor server 160 in accordance with a third embodiment of the invention. FIG. 22 is a graphical representation of the execution of the method of FIGS. 21A-21B, with the respective steps performed by the payor, the payee, EPS, and the payment processor.

In step S2101, the EPS server 150 captures payor and payee banking information. The EPS server 150 forwards such information to the payment processor server 160.

In step S2102, the payment processor server 160 conducts validation and security checks on the received banking information. The payment processor server 160 transmits the results of these checks to the EPS server 150. It will be appreciated that the EPS server 150 may be configured so as to prevent payors and payees from participating in a transaction until their banking information has been approved. It will be appreciated that the EPS server 150 may itself be capable of conducting the validation and security checks, and in such an instance, the EPS server 150 will perform such checks without involving the payment processor server 160.

In step S2103, the EPS server 150 sends an instruction to the payment processor server 160 with information regarding the payor and the transaction. This information includes at least the payor's bank account information, along with the amounts of the transaction payment and fees for debit from the payor's account. Alternatively, if the payor's bank account information is pre-stored and is identifiable by the EPS server 150 and the payment processor server 160 using another identifier, that other identifier may be used instead.

In step S2104, the payment processor server 160 creates a unique and discrete financial account affiliated with the transaction. This unique financial account is also referred to herein as a sub-account. This sub-account will subsequently store the funds debited from the payor's bank account, and is specific to the transaction. That is, this sub-account is different from all remaining sub-accounts, even in the case where the payee of a first transaction is the same as the payee of a second transaction, or where the payor of a first transaction is the same as the payor of a second transaction.

In step S2105, the payment processor server 160 initiates a debit from the payor's bank account, for the amount of the transaction and the fees, according to the information received in step S2103. The payment processor server 160 stores these debited funds in the sub-account created in step S2104. It will be appreciated that this debit may occur in at least one of two different techniques. First, the payment processor server 160 may transfer received funds directly into the sub-account. Alternatively, the payment processor server 160 may transfer received funds into a general account, and then immediately transfer these funds into the sub-account. The latter method may be preferable so as to conceal the sub-account information from outside financial institutions such as the payor's bank. The latter method may also be preferable when sub-accounts are logical accounts or electronic records. In such an instance, the payment processor server 160 may perform the first transfer from the payor's bank account into a general account via, for example, ACH, while performing the second transfer from the general account into the sub-account via an updating of the appropriate logical account or electronic record. The payment processor server 160 may notify the EPS server 150 once the debit has been completed and the funds are stored in the sub-account.

In step S2106, the EPS server 150 sends a notice to the payee to ship the transaction goods to the payor.

In step S2107, the payee employs a shipping service to ship the transaction goods to the payor.

In step S2108, the shipping service delivers the transaction goods to the payor.

In step S2109, the payee provides proof of delivery to the EPS server 150.

In step S2110, the EPS server 150 sends a notice to the payor, requesting that the payor confirm delivery of the goods.

In step S2111, the payor confirms the receipt of the transaction goods, by responding to the notice sent by the EPS server 150 in step S2110.

In step S2112, the EPS server 150 starts a timer according to a predetermined time period. The predetermined time period is the period provided to the payor to inspect the delivered goods and raise an objection as to the shipment. For instance, the payor may object that certain transaction goods are missing from the shipment. Or, the payor may object that the delivered goods are defective or inconsistent with a description of these goods provided by the payee during the pendency of the transaction.

In step S2113, the EPS server 150 awaits an acceptance or an objection from the payor. If the payor accepts the goods, the EPS server 150 proceeds to step S2116. If the payor objects to the goods, the EPS server 150 proceeds to step S2114. If the payor has not provided either an acceptance or an objection, the EPS server 150 proceeds to step S2115.

In step S2114, an objection lodged by the payor as to the transaction goods causes a dispute resolution proceeding and/or an arbitration proceeding to be commenced to resolve the dispute. Meanwhile, the payment processor server 160 maintains the funds stored in the sub-account pending a dispute resolution or an arbitration decision. It will be appreciated that the payor or payee may initiate dispute resolution and/or arbitration via any acceptable method. For instance, the payor may initiate the dispute resolution and/or arbitration via the EPS server 150.

In step S2115, the EPS server 150 determines whether the timer set in step S2112 has expired. If the timer has not expired, the EPS server 150 returns to step S2113. If the timer has expired, the EPS server 150 proceeds to step S2116.

It will be appreciated that steps S2112-S2115 may be optional steps in accordance with a desired operation of the system, and that the system may be operated such that delivery confirmation by the payor and/or payee is a sufficient condition for disbursement of funds.

In step S2116, the EPS server 150 sends a credit instruction to the payment processor server 160 to disburse the funds in the sub-account.

In step S2117, the payment processor server 160 initiates a disbursement of funds to the payee's bank account. These funds represent the payment for the transaction goods, and customarily will equal the amount debited in step S2105, less any fees that the escrow payment service and/or the payment processor deducts for its contributed services in the transaction. The disbursement may occur in a similar manner to the transfer(s) in step S2105. That is, the payment processor server 160 may transfer the funds directly from the sub-account to the payee's bank account. Alternatively, the payment processor server 160 may transfer the funds into the general account, and then immediately transfer these funds into the payee's bank account. The latter method may be preferable so as to conceal the sub-account information from outside financial institutions such as the payee's bank. The latter method may also be preferable when sub-accounts are logical accounts or electronic records. In such an instance, the payment processor server 160 may perform the first transfer from the sub-account account into the general account via an updating of the appropriate logical account or electronic record, while performing the second transfer from the general account into the payee's bank account via, for example, ACH.

In step S2118, the payment processor server 160 initiates a disbursement of funds to EPS's bank account for any fees associated with its escrow services. The payment processor server 160 may also disburse to itself the fees associated with its own services. These disbursement(s) may occur in the same manner as described above with respect to step S2117, or alternatively may occur via any other transfer methodology established between the payment processor and EPS.

At this stage, the balance of the sub-account should be zero. In Step S2119, the payment processor server 160 closes the sub-account.

It will be appreciated that the transaction may alternatively or additionally involve services or other contractual obligations instead of goods, and the steps described in FIGS. 21A-21C may be modified as appropriate for confirming the receipt of such services or contractual obligations. For instance, if the transaction involves a service or other contractual obligation, steps S2106-S2111 may be skipped and steps S2112-S2115 may alternatively correspond to the acceptance of the service or contractual obligation. Of course, even with goods, any type of condition may be alternatively used to trigger a timer and/or the disbursement of funds. Examples include, but are not limited to, shipping, tracking, delivery confirmation, and delivery & inspection clocks.

It will further be appreciated that EPS server 150 may alternatively have the ability to create, administer, and terminate sub-accounts, instead of payment processor server 160. For instance, EPS server 150 may incorporate electronic records which uniquely identify each transaction and funds corresponding to the transaction, and the available balance for that transaction. In such an instance, payment processor server 160 may operate the transfers between external accounts (e.g., ACH), while EPS server 150 provides the functionality for the administration of sub-accounts.

It will even further be appreciated that the debit in steps S2103-S2105 is not limited to a single payor bank account, but may alternatively constitute multiple debits from multiple accounts affiliated with the payor and/or an associate of the payor. That is, the sub-account may be funded by multiple funding sources. Similarly, it will be appreciated that the disbursement in steps S2116 and S2117 is not limited to a single payee bank account, but may alternatively constitute multiple credits to multiple accounts affiliated with the payee and/or an associate of the payee. That is, the sub-account funds may be disbursed to multiple funding recipients.

It will also be appreciated that debit and credit requests may be processed in real-time, batch, or hybrid real-time/batch as explained above with reference to FIGS. 12-14.

In the foregoing description, example aspects of the present invention are described with reference to specific example embodiments. Despite these specific embodiments, many additional modifications and variations would be apparent to those skilled in the art. Thus, it is to be understood that example embodiments of the invention may be practiced in a manner other than those specifically described. Accordingly, the specification is to be regarded in an illustrative rather than restrictive fashion. It will be evident that modifications and changes may be made thereto without departing from the broader spirit and scope. For instance, it will be appreciated that while the example aspects of the present invention generally involve online transactions, the invention is not limited thereto, but also covers offline or any other form of transaction.

Similarly, it should be understood that the figures are presented solely for example purposes. The architecture of the example embodiments presented herein is sufficiently flexible and configurable such that it may be practiced in ways other than that shown in the accompanying figures.

Furthermore, the purpose of the foregoing abstract is to enable the U.S. Patent and Trademark Office, the general public, and scientists, engineers, and practitioners in the art who are unfamiliar with patent or legal terms or phrases, to quickly determine from a cursory inspection the nature and essence of the technical disclosure of the application. The abstract is not intended to limit the scope of the present invention in any way. It is also to be understood that the processes recited in the claims need not be performed in the order presented.

What is claimed is:

1. A method of coordinating payment between a payor and a payee of a transaction for a contractual obligation, comprising:
electronically receiving bank account information from an online entity administering the transaction, the bank account information including information on (1) a payor bank account corresponding to the payor, and (2) a payee bank account corresponding to the payee;
electronically receiving transaction information from the online entity, the transaction information including a payment amount to be paid by the payor to the payee for the contractual obligation;
electronically transmitting a debit request to a payment processor, the debit request including instructions to (1) create a discrete financial account specific to the transaction, (2) debit, from the payor bank account, a debit amount equal to or greater than the payment amount, (3) transfer the debit amount to the discrete financial account, and (4) hold the debit amount in the discrete financial account; and
electronically transmitting, after a confirmation that the contractual obligation has been at least partially satisfied, a credit request to the payment processor, the credit request including instructions to (1) transfer a credit amount from the discrete financial account, and (2) credit, to the payee bank account, the payment amount,
wherein said bank account information electronic receiving step, said transaction information electronic receiving step, said debit request electronic transmitting step, and said credit request electronic transmitting step are implemented using at least one processor and at least one memory.

2. A method according to claim 1, wherein said bank account information electronic receiving step is performed prior to the payor and the payee completing negotiation of the transaction, and
wherein said transaction information electronic receiving step is performed after the payor and the payee complete negotiation of the transaction.

3. A method according to claim 1, wherein the online entity is an online auction service.

4. A method according to claim 1, wherein the contractual obligation is a delivery of a good or a completion of a service.

5. A method according to claim 1, further comprising:
electronically transmitting a request for conducting a security check on the payee; and
electronically receiving the results of the security check.

6. A method according to claim 1, further comprising:
electronically transmitting a request for conducting a security check on the payor; and
electronically receiving the results of the security check.

7. A method according to claim 1, wherein said credit request electronically transmitting step is performed only after at least one release condition is satisfied.

8. A method according to claim 7, wherein at least one release condition includes a confirmation that the payee accepts that the contractual obligation has been fully satisfied.

9. A method according to claim 7, further comprising:
electronically initiating a timer, after the confirmation that the contractual obligation has been at least partially satisfied,
wherein the at least one release condition includes (1) an expiration of the timer, and (2) a confirmation that the payee accepts that the contractual obligation has been fully satisfied.

10. A method according to claim 9, wherein the payment processor continues to hold the debit amount upon a confirmation that the payee has rejected the contractual obligation as not being fully satisfied.

11. A method according to claim 1, further comprising:
electronically transmitting a second credit request to the payment processor, the second credit request including instructions to (1) transfer a transaction fee amount from the discrete financial account, and (2) credit, to a transaction-fee bank account, the transaction fee amount.

12. A method according to claim 11, wherein the transaction fee corresponding to the transaction fee amount is an online entity transaction fee, and
wherein the transaction-fee bank account is associated with the online entity.

13. A method according to claim 11, wherein the transaction fee corresponding to the transaction fee amount is an escrow service transaction fee, and
wherein the transaction-fee bank account is associated with the escrow service.

14. A method according to claim 1, wherein the transmitting in said debit request electronic transmitting step and said credit request electronic transmitting step is performed in real-time.

15. A method according to claim 1, wherein the transmitting in said debit request electronic transmitting step and said credit request electronic transmitting step is performed as a periodic transmission of a batch of debit requests and credit requests.

16. A method according to claim 1, said debit request electronic transmitting step includes:
electronically creating a release list of requests to release, if a release list does not already exist;
electronically transmitting a validation request of the debit request to the payment processor;
electronically adding the debit request to the release list, after receiving a confirmation that the debit request is valid;
electronically transmitting the release list to the payment processor; and
discarding the release list.

17. A method according to claim 16, wherein said release list electronic creating step occurs at the beginning of a business day,
wherein said validation request electronic transmitting step occurs upon the receiving of transaction information from the online entity, and
wherein said release list electronic transmitting step occurs at the end of the business day.

18. A method according to claim 1, said credit request electronic transmitting step includes:
electronically creating a release list of requests to release, if a release list does not already exist;
electronically transmitting a validation request of the credit request to the payment processor;
electronically adding the credit request to the release list, after receiving a confirmation that the credit request is valid;
electronically transmitting the release list to the payment processor; and
discarding the release list.

19. A method according to claim 18, wherein said release list electronic creating step occurs at the beginning of a business day,
wherein said validation request electronic transmitting step occurs upon the receiving of transaction information from the online entity, and
wherein said release list electronic transmitting step occurs at the end of the business day.

20. A method according to claim 16, wherein the release list in said debit request electronic transmitting step is a debit release list, and
wherein said credit request electronic transmitting step includes:
electronically creating a credit release list of requests to release, if a credit release list does not already exist, the credit release list being different from the debit release list;
electronically transmitting a validation request of the credit request to the payment processor;
electronically adding the credit request to the credit release list, after receiving a confirmation that the credit request is valid;
electronically transmitting the credit release list to the payment processor; and
discarding the credit release list.

21. A method according to claim 1, wherein the payment processor closes the discrete financial account upon completion of all payments for the transaction.

22. A method of coordinating a plurality of payments, each payment corresponding to a transaction between a payor and a payee for a contractual obligation, comprising:
electronically receiving, for each of the transactions, bank account information from an online entity administering the transaction, the bank account information including information on (1) a payor bank account corresponding to the respective payor, and (2) a payee bank account corresponding to the respective payee;
electronically receiving, for each transaction, transaction information from the online entity, the transaction information including a payment amount to be paid by the respective payor to the respective payee for the respective contractual obligation;
electronically transmitting, for each of the transactions, a debit request to a payment processor, the debit request including instructions to (1) create a discrete financial account specific to the transaction, (2) debit, from the respective payor bank account, a debit amount equal to or greater than the respective payment amount, (3) transfer the debit amount to the discrete financial account, and (4) hold the debit amount in the discrete financial account; and
electronically transmitting, for each of the transactions and after confirmation that the contractual obligation has been at least partially satisfied, a credit request to the payment processor, the credit request including instructions to (1) transfer a credit amount from the respective discrete financial account, and (2) credit, to the respective payee bank account, the respective payment amount,
wherein said bank account information electronic receiving step, said transaction information electronic receiving step, said debit request electronic transmitting step, and said credit request electronic transmitting step are implemented using at least one processor and at least one memory.

23. A method according to claim 22, wherein said bank account information electronic receiving step is performed prior to each respective payor and each respective payee completing negotiation of the respective transaction, and
wherein said transaction information electronic receiving step is performed after each respective payor and each respective payee complete negotiation of the respective transaction.

24. A method according to claim 22, wherein the online entity is an online auction service.

25. A method according to claim 22, wherein the contractual obligation is a delivery of a good or a completion of a service.

26. A method according to claim 22, further comprising:
electronically transmitting a request for conducting a security check on each payee; and
electronically receiving the results of the security check.

27. A method according to claim 22, further comprising:
electronically transmitting a request for conducting a security check on each payor; and
electronically receiving the results of the security check.

28. A method according to claim 22, wherein said credit request electronically transmitting step for a respective transaction is performed only after at least one release condition is satisfied.

29. A method according to claim 28, wherein at least one release condition includes a confirmation that the respective payor accepts that the contractual obligation has been fully satisfied.

30. A method according to claim 28, further comprising:
electronically initiating a timer for each of the transactions, after the confirmation that the contractual obligation has been at least partially satisfied,
wherein the at least one release condition includes (1) an expiration of the timer, and (2) a confirmation that the respective payor accepts that the contractual obligation has been fully satisfied.

31. A method according to claim 30, wherein the payment processor continues to hold the debit amount upon a confirmation that the respective payor has rejected the contractual obligation as not being fully satisfied.

32. A method according to claim 22, further comprising:
electronically transmitting, for each of the transactions, a second credit request to the payment processor, the second credit request including instructions to (1) transfer a respective transaction fee amount from the respective discrete financial account, and (2) credit, to a transaction-fee bank account, the respective transaction fee amount.

33. A method according to claim 32, wherein the transaction fee corresponding to the respective transaction fee amount is an online entity transaction fee, and
wherein the transaction-fee bank account is associated with the online entity.

34. A method according to claim 32, wherein the transaction fee corresponding to the respective transaction fee amount is an escrow service transaction fee, and
wherein the transaction-fee bank account is associated with the escrow service.

35. A method according to claim 22, wherein the transmitting in said debit request electronic transmitting step and said credit request electronic transmitting step is performed in real-time.

36. A method according to claim 22, wherein the transmitting in said debit request electronic transmitting step and said credit request electronic transmitting step is performed as a periodic transmission of a batch of debit requests and credit requests.

37. A method according to claim 22, said debit request electronic transmitting step includes:
electronically creating a release list of requests to release, if a release list does not already exist;
electronically transmitting a validation request of the debit request to the payment processor;
electronically adding the debit request to the release list, after receiving a confirmation that the debit request is valid;
electronically transmitting the release list to the payment processor; and
discarding the release list.

38. A method according to claim 37, wherein said release list electronic creating step occurs at the beginning of a business day,
wherein said validation request electronic transmitting step occurs upon the receiving of transaction information from the online entity, and
wherein said release list electronic transmitting step occurs at the end of the business day.

39. A method according to claim 22, said credit request electronic transmitting step includes:
electronically creating a release list of requests to release, if a release list does not already exist;
electronically transmitting a validation request of the credit request to the payment processor;
electronically adding the credit request to the release list, after receiving a confirmation that the credit request is valid;
electronically transmitting the release list to the payment processor; and
discarding the release list.

40. A method according to claim 39, wherein said release list electronic creating step occurs at the beginning of a business day,
wherein said validation request electronic transmitting step occurs upon the receiving of transaction information from the online entity, and
wherein said release list electronic transmitting step occurs at the end of the business day.

41. A method according to claim 37, wherein the release list in said debit request electronic transmitting step is a debit release list, and
wherein said credit request electronic transmitting step includes:
electronically creating a credit release list of requests to release, if a credit release list does not already exist, the credit release list being different from the debit release list;
electronically transmitting a validation request of the credit request to the payment processor;
electronically adding the credit request to the credit release list, after receiving a confirmation that the credit request is valid;
electronically transmitting the credit release list to the payment processor; and
discarding the credit release list.

42. A method according to claim 22, wherein the payment processor closes the discrete financial account upon completion of all payments for the transaction.

43. A method of coordinating a plurality of payments, each payment corresponding to an online transaction between a seller and a buyer for an item, comprising:
electronically receiving, for each of the online transactions, bank account information from an online entity administering the online transaction, the bank account information including information on (1) a seller bank account corresponding to the respective seller, and (2) a buyer bank account corresponding to the respective buyer;
electronically receiving, for each of the online transactions, transaction information from the online entity, the transaction information including a payment amount to be paid by the respective buyer to the respective seller for the respective item;
electronically transmitting a batch debit request to a payment processor, the batch debit request including instructions to, for each of the online transactions, (1) create a discrete financial account specific to the online transaction, (2) debit, from the respective buyer bank account, a debit amount equal to or greater than the respective payment amount, (3) transfer the debit amount to the discrete financial account, and (4) hold the debit amount in the discrete financial account; and
electronically transmitting a batch credit request to the payment processor, the batch credit request including instructions to, for each of the online transactions having a confirmation that the respective buyer has received the respective item, (1) transfer a credit amount from the respective discrete financial account, and (2) credit, to the respective seller bank account, the payment amount,
wherein said bank account information electronic receiving step, said transaction information electronic receiving step, said debit request electronic transmitting step, and said credit request electronic transmitting step are implemented using at least one processor and at least one memory.

44. A method of coordinating payment between a seller and a buyer of an online transaction for an item, comprising:
electronically receiving bank account information, the bank account information including information on (1) a seller bank account corresponding to the seller, and (2) a buyer bank account corresponding to the buyer;
checking the seller bank account and the buyer bank account for security compliance;
electronically receiving transaction information, the transaction information including a payment amount to be paid by the buyer to the seller for the item;
electronically creating a discrete financial account specific to the online transaction;
electronically debiting, from the buyer bank account, a debit amount equal to or greater than the payment amount;
electronically transferring the debit amount to the discrete financial account;
holding the debit amount in the discrete financial account;
electronically receiving a notification that the buyer has received the item;
electronically transferring a credit amount from the discrete financial account; and
electronically crediting, to the seller bank account, the credit amount,
wherein said bank account information electronic receiving step, said transaction information electronic receiving step, said electronic creating step, said electronic debiting step, said debit amount electronic transferring step, said notification electronic receiving step, said credit amount electronic transferring step, and said electronic crediting step are implemented using at least one processor and at least one memory.

45. A method according to claim 44, wherein the bank account information received in said bank account information electronic receiving step includes information on a plurality of potential seller bank accounts corresponding to a plurality of potential sellers for the online transaction, one of the potential sellers being selected as the seller for the online transaction,
wherein said checking step includes checking the plurality of potential seller bank accounts for security compliance, and
wherein the transaction information received in said transaction information electronic receiving step includes information on the potential seller out of the plurality of potential sellers that has been selected as the seller.

46. A method according to claim 45, wherein said bank account information electronic receiving step is performed prior to a completion of negotiation of the online transaction,
wherein the seller is selected out of the plurality of potential sellers during the negotiation of the online transaction or at the completion of negotiation of the online transaction. and
wherein said transaction information electronic receiving step is performed after the completion of negotiation of the online transaction.

47. An apparatus for coordinating payment between a payor and a payee of a transaction for a contractual obligation, comprising:
a bank account information reception module that receives, from an online entity administering the transaction, bank account information including information on (1) a payor bank account corresponding to the payor, and (2) a payee bank account corresponding to the payee;
a transaction information reception module that receives, from the online entity, the transaction information including a payment amount to be paid by the payor to the payee for the contractual obligation;
a debit request transmission module that transmits, to a payment processor, a debit request including instructions to (1) create a discrete financial account specific to the transaction, (2) debit, from the payor bank account, a debit amount equal to or greater than the payment amount, (3) transfer the debit amount to the discrete financial account, and (4) hold the debit amount in the discrete financial account; and
a credit request transmission module that transmits, after a confirmation that the contractual obligation has been at least partially satisfied, a credit request to the payment processor, the credit request including instructions to (1) transfer a credit amount from the discrete financial account, and (2) credit, to the payee bank account, the payment amount.

48. A computer program product comprising a non-transitory computer-readable medium having control logic stored thereon for causing a computer to coordinate payment between a payor and a payee of a transaction for a contractual obligation, the control logic comprising computer readable program code which, when executed, causes the computer to perform the steps of:
electronically receiving bank account information from an online entity administering the transaction, the bank account information including information on (1) a payor bank account corresponding to the payor, and (2) a payee bank account corresponding to the payee;
electronically receiving transaction information from the online entity, the transaction information including a payment amount to be paid by the payor to the payee for the contractual obligation;
electronically transmitting a debit request to a payment processor, the debit request including instructions to (1) create a discrete financial account specific to the transaction, (2) debit, from the payor bank account, a debit amount equal to or greater than the payment amount, (3) transfer the debit amount to the discrete financial account, and (4) hold the debit amount in the discrete financial account; and
electronically transmitting, after a confirmation that the contractual obligation has been at least partially satisfied, a credit request to the payment processor, the credit request including instructions to (1) transfer a credit amount from the discrete financial account, and (2) credit, to the payee bank account, the payment amount.
